(19) United States
(12) Patent Application Publication
(10) Pub. No.: US 2011/0277492 A1
(43) Pub. Date: Nov. 17, 2011

(54) ADDUCTION ASSEMBLY FOR AN AIR CONDITIONING SYSTEM AND MANUFACTURING METHOD THEREOF

(76) Inventor: Roberto Defilippi, Torino (IT)

(21) Appl. No.: 13/057,618

(22) PCT Filed: Aug. 6, 2009
(86) PCT No.: PCT/IB2009/006476

§ 371 Date: Aug. 4, 2011

(30) Foreign Application Priority Data
Aug. 6, 2008 (IT) TO2008A000624

(51) Int. Cl. B60H 1/32; B29C 65/16; F16L 13/02

(52) U.S. Cl. 62/239; 285/288.1; 156/272.8

(57) ABSTRACT

A coolant adduction assembly for a climate control system of a vehicle, characterized in that it comprises a joint and a tube inserted into said joint, wherein said pipe and joint comprise a thermoplastic material and are rigidly connected by means of a laser welding.

### TECHNICAL FIELD

The present invention relates to an adduction assembly for an air conditioning system of a motor vehicle and to a manufacturing method thereof.

### BACKGROUND ART

The air conditioning systems of motor vehicles are circuits where a coolant flows and are formed by a plurality of components, comprising in particular a compressor, a condenser, a dryer tank, and expansion system, and an evaporator. All these components are connected to one another by means of tubular elements which have fixing elements and joining elements capable of ensuring fluid-tightness at their ends.

The constituent components of the air conditioning system are accommodated inside the engine compartment of the vehicle, with the compressor driven by the driving shaft of the vehicle, while the other components are fixed to portions of the body. There are low pressure elements and high pressure elements in the air conditioning system. The latter may be subjected in use to coolant pressures of the order of 30 bars.

Freon gas named “R-134” has been used for a long time as refrigerating fluid in cars. In order to avoid pollution of such a gas, it is particularly important for an adduction pipe to be substantially impermeable. Furthermore, low permeability is also desirable for the system to keep its functionality and efficiency over time.

However, international standards concerning the environment enforce seeking alternative solutions to Freon R-134 with a lower GWP (Global Warming Potential). Among these, the effectiveness of gas 1234 YS proposed by Honeywell and Dupont has been proven. In all cases, even when using a gas with lower GWP as a refrigerant, all elements, i.e. adducting pipes and joints, must have the lowest possible permeability, in combination with satisfactory high-pressure mechanical properties, in particular after aging and substantially over the entire lifecycle of the motor vehicle.

In particular, car manufacturers require that the lines formed by adducting pipes and joints in the air conditioning system pass a plurality of experimental tests, e.g. hot burst tests for checking the mechanical features, strength tests to cyclic pressure variations, fluid permeability tests and chemicals resistance tests.

In automotive air conditioning systems, these requirements are generally met by using aluminum piping for conveying the refrigerant fluid, at the ends of which brazed flanges and intermediate rubber pipes with bell-shaped joints or quick couplings moulded on the rubber itself are used, by possibly using such a metal in combination with multi-layer rubber pipes.

However, the general trend in the automotive field is to replace the metal or rubber piping where possible with equivalent structures made of plastic, so as to promote a reduction of manufacturing costs in addition to the total weight of the resulting air conditioning system, being thus beneficial for engine CO₂ emissions by virtue of lower consumptions.

Upon the use of a plastic pipe for an air conditioning system the need arises to connect the joint to the tube according to a mode adapted to ensure both high mechanical resistance and low coolant permeation levels.

### OBJECT OF THE INVENTION

It is thus the object of the present invention to provide an adduction assembly capable of effectively replacing the aluminum elements currently used in air conditioning systems in the automotive field.

According to the present invention, an adduction assembly for an air conditioning circuit is provided according to claim 1. Furthermore, claim 7 relates to a method for manufacturing the adduction assembly according to the present invention.

### BRIEF DESCRIPTION OF THE DRAWINGS

For a better understanding, the present invention will now be further described with reference to the accompanying drawings, in which in particular:

FIG. 1 is an air conditioning circuit diagram; and

FIG. 2 is a perspective view of a coolant adduction assembly of the circuit in FIG. 1.

### BEST MODE FOR CARRYING OUT THE INVENTION

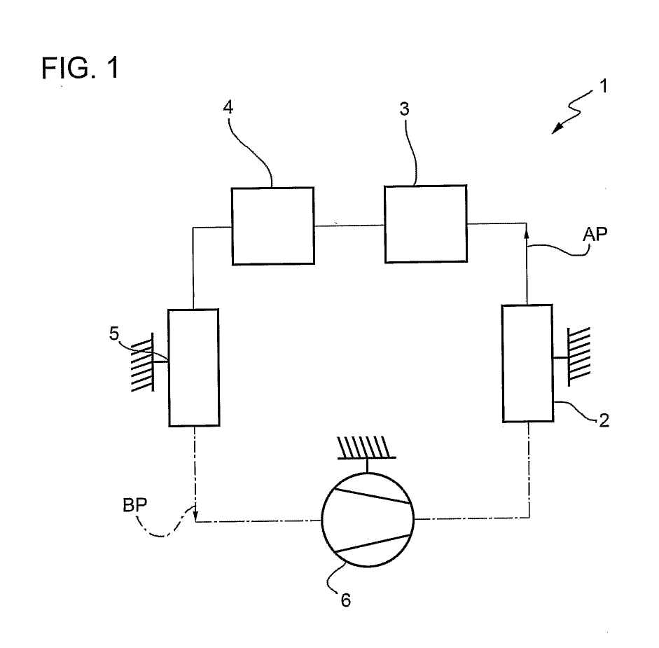

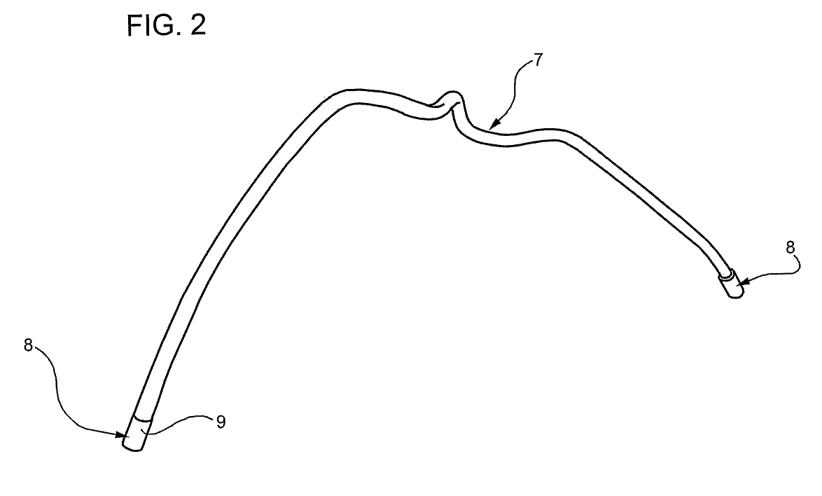

In FIG. 1, numeral 1 indicates as a whole an air conditioning system for a motor vehicle, comprising a condenser 2, a dryer tank 3, an expansion system 4, an evaporator 5, a compressor 6. A low pressure section BP is identified in FIG. 1 by a dashed-dotted line. A solid line indicates instead a high pressure section AP, substantially identifiable between the compressor 6 and the expansion system 4. In the high pressure section AP, the coolant (R-134) is in use at temperatures of about 100° C. and at a pressure of the order of 20 bars. The air conditioning system components outlined in FIG. 1 are connected to one another by means of a plurality of hollow components, i.e. pipes 7 and respective joints 8 (FIG. 2).

Joint 8 comprises a tubular portion 9 within which an end portion of the pipe 7 is axially inserted by radial interference. The portion, the joint 8 and the pipe 7 are then welded together by a laser light beam, as will be described in greater detail below, and the value of the interference is such to maintain the joint 8 in the correct position with respect to the pipe 7 during the welding operation.

According to a preferred embodiment, pipe 7 and joint comprise a layer comprising a thermoplastic copolymer comprising polyamide 6.10.

The layer comprising polyamide 6.10 preferably comprises more than 60% of polyamide 6.10. More preferably, the layer comprises more than 90% of polyamide 6.10. Even more preferably, the layer is completely made of polyamide 6.10.

Polyamide 6.10 preferably comprises more than 60% of a copolymer obtained from a first monomer comprising sebacic acid units and from a second monomer comprising hexamethylenediamine units. More preferably, polyamide 6.10 comprises more than 90% of a copolymer obtained from a first monomer comprising sebacic acid units and from a second monomer comprising hexamethylenediamine units. Even more preferably, polyamide 6.10 consists in a copolymer obtained from a first monomer comprising sebacic acid units and from a second monomer comprising hexamethylenediamine units.

A resin of Grilamid® S series from EMS is preferably used. For example, Grilamid® S FR5347 resin may be used.

Such a resin, having a density of about 1.07 g/cm³, has a melting point of about 220° C. and a Young's modulus of about 2.3 GPa. Furthermore, an element made of such a resin has properties of high chemical resistance to oils, e.g. PAG2 or POE, fuels, water and salt solutions, good short-term heat resistance and hydrolysis resistance properties, reduced tendency to absorb water, and a better mechanical stability and resistance to abrasion, as compared to pipes made of other polyamides, such as PA6 and PA12.

Furthermore, since one of its constituent monomer units is mainly sebacic acid (a compound abundantly available in nature as obtained from castor oil), its use advantageously is a form of use of renewable resources. Joint 8 preferably comprises a fiber filler, more preferably a glass fiber filler.

The glass fibers are preferably added to the polyamide in an amount by weight between 10 and 60%. Optimal test results have been obtained with a percentage by weight between 20 and 40%, e.g. 30%.

According to a preferred embodiment of the invention, the glass fibers have a length between 0.05 and 1.0 mm, but even more preferably have a length between 0.1 and 0.5 mm.

Furthermore, these fibers preferably have a diameter between 5 and 20 μm, and more preferably have a diameter between 6 and 14 μm.

Joint 8 preferably comprises at least 60% of such a polyamide 6.10 filled with glass fibers. More preferably, joint 8 comprises at least 90% of such a polyamide 6.10 filled with glass fibers. Even more preferably, it is completely made of such a polyamide 6.10 filled with glass fibers.

According to an embodiment, the pipe 7 consists of a single layer comprising polyamide 6.10 not filled with glass fibers as described in the previous paragraphs, and preferably has a thickness between 1.5 and 3 mm.

According to an alternative embodiment of the invention, the pipe 7 may comprise a second layer comprising a polyamide resin preferably selected from polyamide 12 and copolyamide obtained from dicarboxylic units, which are terephthalic acid or isophthalic acid by more than 60%. If the pipe 7 is multi-layered, the joint is made of thermoplastic material adapted to be welded to the material of the outermost layer of pipe 7. Joint 8 preferably comprises the same thermoplastic material of which the outermost layer of pipe 7 is made.

The second layer preferably comprises at least 60% of said polyamide resin. More preferably, the second layer comprises at least 90% of said polyamide resin. Even more preferably, the second layer is completely made of said polyamide resin.

According to an embodiment of the invention, said polyamide resin is polyamide 12 modified to withstand cold impacts.

Polyamide 12 is preferably selected so as to have a melting point between 170 and 176° C., a tensile stress between 25 and 35 MPa, a flexural strength between 20 and 30 MPa, a flexural modulus between 400 and 600 MPa, an impact resistance between 100 and 120 kJ/m² at 23° C. and between 10 and 20 kJ/m² at −40° C.

The pipe preferably comprises a first layer comprising polyamide 6.10 and a second layer comprising polyamide 12, the first layer being within the second layer.

According to a further embodiment of the invention, such a copolyamide is polyphthalamide (PPA).

Such a copolyamide is preferably obtained from carboxylic units, which are terephthalic acid by more than 60%, and diamine units which are 1,9-nonanediamine or 2-methyl-1,8-octanediamine, by more than 60%.

More preferably, the dicarboxylic units are terephthalic acid by more than 90%. Even more preferably terephthalic acid is 100% of the dicarboxylic units.

The diamine units preferably are 1,9-nonanediamine or 2-methyl-1,8-octanediamine by more than 60%. More preferably, the diamine units are 1,9-nonanediamine or 2-methyl-1,8-octanediamine by more than. Even more preferably, 1,9-nonanediamine or 2-methyl-1,8-octanediamine are 100% of the diamine units.

Examples of dicarboxylic units other than terephthalic acid comprise dicarboxylic aliphatic acids such as malonic acid, dimethylmalonic acid, succinic acid, glutaric acid, adipic acid, 2-methyladipic acid, trimethyladipic acid, pimelic acid, 2,2-dimethylglutaric acid, 3,3-diethylsuccinic acid, azelaic acid, sebacic acid, and suberic acid; alicyclic dicarboxylic acids such as 1,3-cyclopentanedicarboxylic and 1,4-cyclohexanedicarboxylic acid; aromatic dicarboxylic acids such as isophthalic acid, 2,6-naphthalenedicarboxylic acid, 2,7-naphthalenedicarboxylic acid, 1,3-phenylenedioxy diacetic acid, diphenic acid, 4,4′-oxydibenzoic acid, diphenylmethane-4,4′-dicarboxylic acid, diphenylsulfone-4,4′-dicarboxylic acid and 4,4′-biphenyldicarboxylic acid; or a mixture thereof.

Among these, aromatic dicarboxylic acids are preferred.

Examples of diamine units other than above-mentioned 1,9-nonanediamine and 2-methyl-1,8-octanediamine comprise aliphatic diamines, such as ethylenediamine, propylenediamine, 1,4-butanediamine, 1,6-hexanediamine, 1,8-octanediamine, 1,10-decanediamine, 3-methyl-1,5-pentanediamine; alicyclic diamines such as cyclohexanediamine, methyl cyclohexanediamine and isophoronediamine; aromatic diamines such as p-phenylenediamine, m-phenylenediamine, p-xylenediamine, m-xylenediamine, 4,4′-diaminodiphenylmethane, 4,4′-diaminodiphenylsulfone, 4,4′-diaminodiphenyl ether; and an arbitrary mixture thereof.

Such a polyamide is preferably P9T of the type described in U.S. Pat. No. 6,989,198. More preferably, the polyamide resin is a Genestar® resin from Kuraray. Even more preferably, it is a Genestar® resin from Kuraray, e.g. Genestar 1001 U03, U83, or H31.

The adduction assembly comprising the joint 8 and the pipe 7 according to the preceding paragraphs meets the requirements set by car manufacturers for use in air conditioning systems. In particular, the layer made of PA 6.10 is able to meet the requirements of permeability and resistance to pressure oscillations, even after aging. Furthermore, coupling the layer made of PA 6.10 with an outer layer made of PA12, PPA or P9T allows to overcome the problems related to resistance to chemical etching, thus avoiding flaking and breakage at the welding points, and related to the limited strength of the threading.

### Example 1

A single layer pipe made of Grilamid S FE 5347, about 7×11, mounted to a joint 8 made of Grilamid S FE 5351 7×11 with 30% glass fibers and red colored in order to be transparent to laser light.

The laser source is a diode source and has a maximum power of 50 W. The beam is conveyed by optical fibers and focused by means of cylindrical optics so as to generate a blade-shaped laser spot.

According to a non-limitative embodiment, joint 8 and pipe 7 overlap in the axial direction over 13 mm and the length of the laser blade is shorter than the overlapping section, e.g. the length of the blade is 11 mm.

The adduction assembly 1 is rotated on a spindle while the laser light blade stays fixed.

The primary need of a refrigerant adduction assembly is to avoid leakages. For this purpose, the pass speed and the beam power need to be determined once the geometry of the laser light spot has been fixed.

An excessively powerful beam would cause burns and/or bubbles along the welding area. An excessively fast pass speed could, instead, disperse the beam energy and cause lack of melting in some zones of the welding area. In both cases, the fluid-tightness of the adduction assembly is compromised.

According to the present invention, it has been checked that a rotation speed between 2 and 9 seconds per revolution, preferably 6 seconds per revolution, i.e. from 230 to 1037 mm/min, preferably 345 mm/min in combination with the laser beam having a linear power density between 2 and 3.5 kW/mm, preferably 2.7 kW/mm allow to obtain a homogenous melting of the overlapping walls of joint 8 and pipe 7, respectively, so as to obtain a continuous, bubble-free welding.

### Hot Burst Tests

The tests were carried out at a temperature of 120° C., after stabilization for 1 h at the test temperature. An increasing hydraulic pressure was applied to the previously described pipe, with 5 bars/s increase until bursting of the pipe. The burst pressure is then compared with the specified values, e.g. by a car manufacturer, for use.

The test was further carried out after the pulsating pressure tests (described below), thus registering a value of 89-92 bars, again clearly over the specified 30 bars.

### Permeability Tests

The objective of these tests is to measure the amount of fluid which exits through the wall of the pipes by means of weight loss. In order to obtain statistically significant data, the tests are simultaneously carried out on 4 pipes.

Firstly, the lengths (L₁, L₂ . . . L₄) of the pipes under test, excluding the joints, are measured at atmospheric pressure. Two closing devices, one of which is provided with a filling valve, are mounted at the ends of the pipes.

The inner theoretical volume of the first 3 pipes is calculated and an amount of 0.55 g/cm³ of HFC134, which is about 50% of the inner volume of the pipe under test, is introduced into the same. The absence of leakages from the closing devices is checked by means of a halogen detector.

The 4 pipes (3 full pipes plus the blank sample) are introduced into an environmental chamber at the temperature of 100° C. for 1 h, then the halogen detector check is repeated. At this point, the 4 pipes are conditioned in the environmental chamber at 100° C. for 24 h.

At the end of the this step of conditioning, the pipes are weighed and their values P₁, P₂, . . . P₄ are registered.

The pipes 7 are thus conditioned again at 100° C. for 72 h, after which they are weighed and the single weight losses ΔPᵢ are determined. The weight loss of the pipes filled with coolant is then evaluated as an average value on the three pipes, and the value measured for the “blank” pipe is then subtracted. The resulting difference is the permeability index in g/m²/72 h.

A value lower than 1.82 g/m²/72 h was registered for the pipe according to the invention.

### Pulsating Pressure Strength Tests

The pipes 7 under examination are mounted on a test bench provided with a device capable of sending pressure pulses. The pipes mounted in a U, with curvature radius equal to the minimum radius contemplated for the pipe under examination, are internally filled either with the lubricant provided for the compressor or with a silicone oil; the environment in which the test is conducted contains air. The inner fluid and the air are taken to a temperature of 100-120° C. and subjected to cycles with test pressure of 0±3.5 MPa (or from 0 to 1 MPa, according to the type of pipe), with a test frequency of 15 cycles per minute. At least 150,000 cycles are carried out until breakage if this does not occur within the 150,000 cycles.

At the end, a check cycle is run, by removing the pipe from the test rig, submerging it in water, and sending a pneumatic pressure of 3.5 MPa for 30 s to check for the lack of leakages. If the presence of bubbles is found, the pressure is kept for 5 minutes in order to ascertain that it is in fact a leakage and not, for example, air possibly trapped between the layers of the pipe (in the case of a multi-layer pipe).

Upon completion of the test, the pipe samples are cut at the joined end zones and visually examined to ascertain the lack of tearing on the inner conduit. The presence of this type of defect would cause test failure.

No breakage occurred after 150,000 cycles for the pipe according to the invention.

### Extraction Tests

The tests are carried out at ambient temperature and after a 1 h permanence at 150° C. at a traction speed of 25 mm/min. The average value of the extraction load which in all cases caused the pipe breakage is 2470 N for the test at ambient temperature and 1172N for the test carried out when hot.

Only the adduction assemblies according to the invention pass all the tests needed to ensure a sufficient duration of the pipe according to the requests of car manufacturers.

The advantages that the joint and the adduction assembly 1 according to the present invention allow to obtain are as follows.

Laser welding for connecting pipe 7 and joint 8 made of plastic material is adapted to meet the requirements of mechanical tightness and permeation required by car manufacturers for supply approval. Thereby, the aluminum pipes may be replaced, thus reducing weights and costs.

Furthermore, according to an alternative embodiment of the present invention, pipe 7 may be multi-layer, e.g. may comprise an intermediate layer of a polyamide having higher toughness and/or ultimate elongation, such as polyamide 6 for example. The aforesaid polyamide 6.10 is preferably used to make an inner layer and an outer layer, while polyamide 6 forms an intermediate layer. Thereby, obtaining a good compromise between chloride resistance, mechanical strength and flexibility of pipe 7 is possible.

Using polyamide 6 increases compatibility with the layers of polyamide 6.10, and polyamide 6.10 in the outer layer allows welding the joint 8 under the best conditions.

According to an embodiment, the outer layer of polyamide 6.10 is thicker than the inner layers of polyamide 6 and polyamide 6.10.

The following table shows the test data according to the previously described modes carried out, unless otherwise specified, on a three-layer pipe 7 in which the layers of polyamide 6.10 are made of a material equivalent to that previously described and polyamide 6 has BRZ 334 degree.

Furthermore, joint 8 may be formed so as to define a coupling hole which accommodates an end portion of the pipe 7. For this purpose, joint 8 is made with a laser light transparent pigmentation so that the latter may be focused on the interface zone between the pipe 7 and an inner surface of the coupling hole.

| | SPECIFIED | | | | |
|---|---|---|---|---|---|
| TEST TYPE | VALUES | VALUES FOUND | | | |
| Extraction load of laser- | >1200N | 1947 | 1934 | 1946 | 1900 |
| welded joints (see*) | | | | | |

| Laser-welded joint | No voids | No voids/defects on 2 sections | | |
|---|---|---|---|---|
| micrography, 0° and 180° | | | | |
| section | | | | |
| Layer thickness | mm | Outer layer: 0.92 mm | | |
| measurement | | Intermediate layer: 0.62 mm | | |
| | | Inner layer: 0.59 mm | | |
| Hot burst test = | >30 bars | 49 | 51 | Full body burst |
| 1 h @ 120° C. | | | | |

*in. all cases, breakage of the joint

1. A coolant adduction assembly for a climate control system of a vehicle, characterized in that it comprises a joint and a pipe inserted into said joint, wherein said pipe and joint comprise a thermoplastic material and are rigidly connected by means of a laser welding.

2. An adduction assembly according to claim 1, characterized in that said thermoplastic material is polyamide.

3. An adduction assembly according to claim 2, characterized in that said thermoplastic material is polyamide 6.10.

4. An adduction assembly according to claim 3, characterized in that said pipe comprises a layer of a polyamide different from polyamide 6.10 and having an ultimate elongation higher than that of polyamide 6.10, and two layers of polyamide 6.10, inner and outer layers, respectively.

5. An adduction assembly according to claim 3, characterized in that said pipe consists of a single layer of polyamide 6.10.

6. An adduction assembly according to claim 1, characterized in that said joint comprises the same thermoplastic material as the outermost layer of said pipe.

7. An adduction assembly according to claim 1, characterized in that said joint defines a hole for accommodating an end portion of said pipe, said joint being made of a laser light transparent material.

8. An air conditioning circuit for a vehicle characterized in that it comprises the adduction assembly according to claim 1.

9. A method of manufacturing an adduction assembly for an air conditioning circuit of a vehicle, comprising a pipe and a joint made of thermoplastic material, said method comprising the step of laser-welding said pipe to said joint.

10. A method according to claim 6, characterized in that the welding speed is between 230 and 1037 mm/min.

11. A method according to claim 10, characterized in that the linear power density of said laser beam is between 2 and 3.5 kW/mm.
